(19) United States
(12) Patent Application Publication
(10) Pub. No.: US 2005/0212683 A1
(43) Pub. Date: Sep. 29, 2005

(54) K-9 protector

(76) Inventor: Louis Beres, Hanmer (CA)

Correspondence Address: Louis Beres, 1180 Ronald Court, Hanmer, ON, P3P 1S2, CA

(21) Appl. No.: 10/808,759

(22) Filed: Mar. 23, 2004

(51) Int. Cl. G08B 3/00

(52) U.S. Cl. 340/691.2; 340/541

(57) ABSTRACT

A motion sensor security light Some electrical wire to hook up a tape player An endless-loop cassette tape A motion sensor security light changed from turning lights to turning a tape player on.

### BACKGROUND OF THE IDEA

Other sensors are connected to a center where police are notified and the person or persons involved have no way of knowing they are immediately being noticed as he does, with the noise form the vicious barking dog. The tape player would be inside the house with the barking dogs turned on loud enough to be heard outside.

### SUMMARY OF THE INVENTION

The idea is cheap, it is available and it is easy to make. It can be put on a tree, a post, or the wall, as long as you have electricity to hook it up and is high enough to not get damaged.

### BRIEF DESCRIPTION OF THE PICTURES

The picture show parts required on two different pages with numbers in different place but explained in the next discription.

### DESCRIPTION OF THE PREFERRED EMBODIMENT

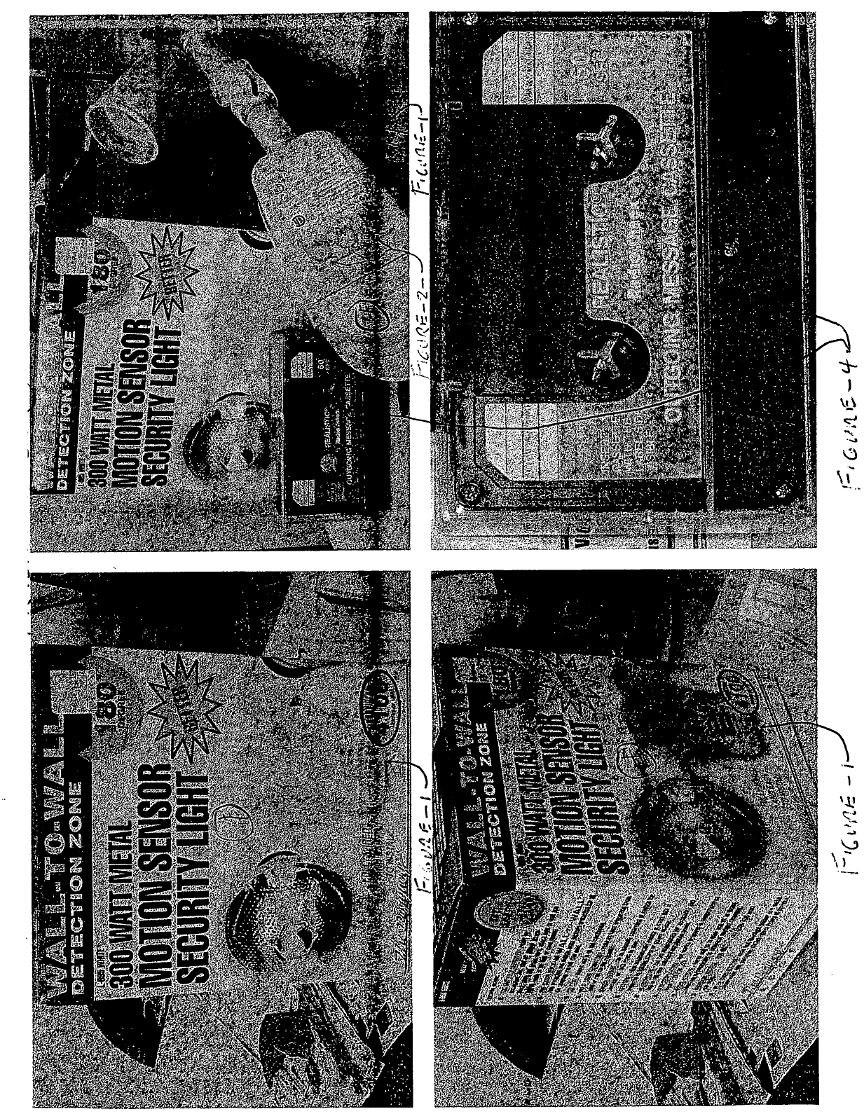

FIG. 1: Pictures page 1 and 2

Shows the body of the motion sensor, it is activated by a motion in it's range, it can be armed or pointed to cover the range required, but it only has a certain range.

FIG. 2: Picture page 1

A picture of the body of the sensor showing three adjusting switches.

They are
1 —a sensitivity switch
2—a day light switch
3—a time switch

FIG. 3: Picture page 2

Shows a tape player with the wires coming in through the wall to a plug. The wire could also come in through the wall to an incoming electrical plug (not shown).

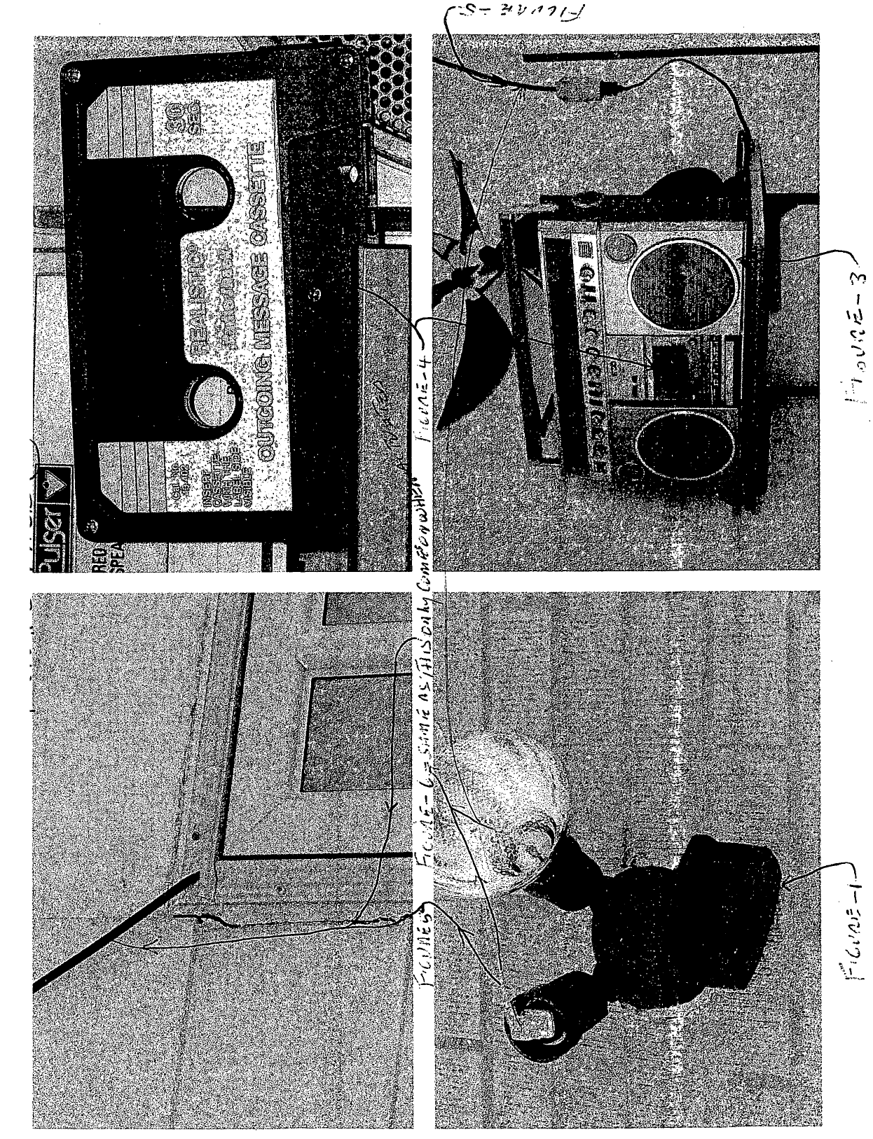

FIG. 4: Pictures page 1 and 2

Show the tape to use. This tape plays the sound of the dogs for 60 seconds over and over again. It never stops replaying itself as long as the power is on.

FIG. 5: Picture page 2

Shows the wire running from the sensor through a hole in the wall and back to the tape player.

FIG. 6: Picture page 1, and 2

Shows the light fixtures attached to the monitor and the power from one of these runs the tape player, but the light fixtures could be removed with only the wire left here to operate the tape player. It would be better without lights but can be left if so desired.

1. What I claim as my invention is to convert a motion sensor security light using the wires that turn this light on whenever the motion sensor is activated by someone or something to operate a tape recorder which would have a tape in it with two vicious barking dogs recorded on this tape. This tape plays for 60 seconds then starts over again as long as the power is on. It is an endless tape that plays the same thing over and over again, but this does not matter as the barking dogs always sound the same.
The motion sensor with lights attached is made to turn lights on whenever anyone or anything approaches it as can be seen in pictures page 1 and pictures page 2. The light fixtures can be removed so that the intruder does not know that he, she or it is being monitored, but lights can be lift on if preferred but the person inside can see outside better to take evasive action. The barking of the dogs inside would not bother neighbours because it would only be heard close by. So you can set it and forget it.
